(19) United States
(12) Patent Application Publication
(10) Pub. No.: US 2023/0128835 A1
(43) Pub. Date: Apr. 27, 2023

(54) HANDHELD WORK APPARATUS

(71) Applicant: Andreas Stihl AG & Co. KG, Waiblingen (DE)

(72) Inventors: Andreas Schulz, Erdmannhausen (DE); Markus Nefzger, Winnenden (DE)

(21) Appl. No.: 17/970,177

(22) Filed: Oct. 20, 2022

(30) Foreign Application Priority Data
Oct. 21, 2021 (EP) 21 203 947.3

(51) Int. Cl. B25F 5/00

(52) U.S. Cl. CPC B25F 5/006; B27B 17/0008

(57) ABSTRACT

A handheld work apparatus has a motor unit including a drive motor for driving a tool and a handle unit including a handle. The motor unit and the handle unit are interconnected via at least one antivibration element. A first antivibration element includes a coil spring. A first holding element is attached in a first end of the coil spring. A second holding element is attached in a second end of the coil spring. The first holding element is firmly connected to the motor unit. The second holding element is firmly connected to the handle unit. The holding elements have end faces located in an interior of the coil spring. The end faces have centering elements that can come into contact with each other and thereby center the holding elements with respect to each other. The end faces form a stop for the movement of the handle.

### CROSS REFERENCE TO RELATED APPLICATION

This application claims priority of European patent application no. 21 203 947.3, filed Oct. 21, 2021, the entire content of which is incorporated herein by reference.

### TECHNICAL FIELD

The disclosure relates to a handheld work apparatus.

### BACKGROUND

Known from US 2011/0226501 is a handheld work apparatus in which a motor unit and a handle unit are connected to each other via at least one antivibration element. There are holding elements screwed into the ends of the coil springs.

### SUMMARY

It is an object of the disclosure to provide a handheld work apparatus with improved guidance properties and improved vibration decoupling.

This object is, for example, achieved by a handheld work apparatus having: a tool; a motor unit having a drive motor configured to drive the tool; a handle unit including a handle; the motor unit and the handle unit being connected to each other via at least one antivibration element; the at least one antivibration element including a first antivibration element having a coil spring, a first holding element, and a second holding element; the first holding element being attached in a first end of the coil spring; the second holding element being attached in a second end of the coil spring; the first holding element being firmly connected to the motor unit; the second holding element being firmly connected to the handle unit; the first holding element having a first end face located in an interior of the coil spring; the second holding element having a second end face located in the interior of the coil spring; the first end face having a first centering element; the second end face having a second centering element; the first centering element and the second centering element being configured to come into mutual contact and thereby center the first holding element and the second holding element with respect to each other; and, the first end face and the second end face forming a stop for a movement of the handle.

In order to achieve good guidance properties during operation even under high loads, it is desirable to limit the relative movement between the motor unit and the handle unit. For this purpose it is known, for example, to provide stop buffers. The present disclosure now provides for a corresponding stop to be formed by the end faces of the holding elements. This avoids the need for additional components for the stop. If the end faces of the holding elements are aligned obliquely with respect to the direction of loading, then, when the end faces of the holding elements are pressed against each other, a force is exerted perpendicularly with respect to the longitudinal center axis of the coil spring of the antivibration element. This force may cause a further relative movement between the motor unit and the handle unit, which is undesirable. Such a force perpendicular to the longitudinal center axis of the coil spring can load components of the work apparatus in unusual directions and consequently result in overloading. In order to avoid such a lateral relative movement of the holding elements with respect to each other, it is provided according to the disclosure that the end faces of the holding elements have centering elements that center the holding elements with respect to each other. In this way, a force and movement in the direction perpendicular to the longitudinal center axis of the coil spring can be easily avoided.

Advantageously, there is at least one operator controlled element located on the handle, for controlling the drive motor. If the handheld work apparatus is a power saw, the handle is particularly preferably a rear handle.

Advantageously, the holding elements are dimensionally stable. For example, the holding elements may be made of dimensionally stable plastic. In an embodiment, one centering element is realized as a cone and the other centering element is realized as a recess. The contour of the cone and that of the recess are advantageously matched to each other. The recess also advantageously has a conical contour.

Particularly advantageously, the first holding element is screwed into the first end of the coil spring, and the second holding element is screwed into the second end of the coil spring. In this configuration, the holding elements serve to fix the coil spring, as a stop and to center the holding elements in relation to each other. This allows for a simple construction with a small number of components. The arrangement of the holding elements inside the coil spring results in a small installation space. The outer circumference of the coil spring is advantageously exposed over the entire length of the coil spring. The holding elements advantageously do not extend radially outside the coil spring.

In an embodiment, the holding element screwed into the first end of the coil spring has a recess as a centering element, and the holding element screwed into the second end of the coil spring has a cone as a centering element. In this case the first holding element is preferably firmly connected to the motor unit, and the second holding element is preferably firmly connected to the handle unit. In an alternative embodiment, the holding element screwed into the first end of the coil spring has a cone as a centering element, and the holding element screwed into the second end of the coil spring has a recess as a centering element.

In an embodiment, when the work apparatus is in a rest position, in which the work apparatus stands on a flat, horizontal rest surface, the longitudinal center axis of the coil spring of the first antivibration element is inclined by an angle of inclination with respect to the rest surface. Preferably, the angle of inclination is more than 0° and less than 90°. In particular, the angle of inclination is more than 45°, preferably more than 60°. An angle of inclination of 60° to 80° is considered to be particularly preferred. In the case of a work apparatus in which the angle of inclination of the antivibration element is significantly greater than 0°, a comparatively large component of a force directed upward at a rear handle of the work apparatus when the work apparatus is in the rest position acts in the longitudinal direction of the coil spring. In particular, in the case of such an antivibration element, a limitation of the maximum distance that the handle unit and motor unit can travel relative to each other is advantageous.

In an alternative embodiment variant, in the rest position the longitudinal center axis of the coil spring of the first antivibration element may be aligned parallel to the rest surface. Particularly preferably, in the case of an arrangement parallel to the rest surface, the longitudinal center axis is inclined by an angle of more than 0°, in particular more than 45°, preferably approximately 90°, with respect to the longitudinal direction of the work apparatus. If the work apparatus is a power saw, the longitudinal center axis of the coil spring is preferably oriented obliquely, in particular perpendicularly, with respect to the plane of a guide bar of the power saw.

The cone angle of the centering element realized as a cone is preferably smaller than the angle of inclination of the longitudinal center axis of the coil spring with respect to the rest surface in the rest position. This ensures that when the handle is moved upward in the rest position, a force is generated at the cone that causes the holding elements to be centered in relation to each other. The cone angle of the centering element realized as a cone is preferably at least 5° smaller than the angle of inclination of the longitudinal center axis of the coil spring.

Advantageously, the first antivibration element has a breakaway safety device, the ends of which are held in the holding elements. To enable easy mounting of the breakaway safety device, it is preferably provided that the holding elements each have a slit that extends from the circumference of a pass-through opening for the breakaway safety device to the outer circumference of the holding element. In this way, the breakaway safety device can be easily mounted on the holding element in the radial direction with respect to the longitudinal center axis, and does not have to be mounted on the holding element, in the longitudinal direction of the holding element, through the pass-through opening for the breakaway safety device.

Advantageously, the pass-through opening expands, in at least one longitudinal portion, in the direction of the end face of the holding element. Since the pass-through opening expands, in at least one longitudinal portion, in the direction of the end face of the holding element, when the motor unit and handle unit move relative to each other in a direction perpendicular to the longitudinal center axis of the coil spring, bearing of the breakaway safety device against the holding device occurs later. As a result, vibrations between the motor unit and the handle unit are transmitted to the coil spring only in the case of larger lateral deflections, that is, transverse loads.

Advantageously, when the work apparatus is in the non-loaded state, the end faces of the holding elements are at a distance from each other. In an embodiment, the distance is at most 30%, in particular at most 20%, of a length of the coil spring. Advantageously, the distance is at most 3 cm, in particular at most 2 cm.

In an embodiment, the holding elements are made of plastic. The end faces of the holding elements in this case may be made of a plastic that is different from that of the main bodies of the holding elements.

Preferably, the centering elements may come into contact with each other when the handle is moved in a direction that corresponds to an upward movement when the work apparatus is in a rest position. Such a movement occurs, for example, in the case of large loads. Here, overloading of the components is to be prevented. In normal operation, the centering elements advantageously do not come into contact with each other, such that a good vibration decoupling of the handle unit and the motor unit is achieved during operation.

The first antivibration element is preferably located adjacent to a front side of the handle that faces toward the tool. The front side of the handle is preferably the region that, in the usual grip position during operation, is closer to a thumb and index finger of the operator than to a little finger of the operator.

The handheld work apparatus is preferably a power saw. In particular, the handheld work apparatus is a manually portable work apparatus.

It may be provided that the fastening elements have at least two regions made of differing materials. Advantageously, the fastening elements, at least in the region of the centering elements, are made of an elastic material, in particular an elastomer. Advantageously, the elastic material is molded onto a main body of dimensionally stable material, for example in a two-component injection molding process.

### BRIEF DESCRIPTION OF THE DRAWINGS

The invention will now be described with reference to the drawings wherein:

FIG. 1 shows a schematic side view of a power saw;

FIG. 2 shows a schematic representation of the power saw from FIG. 1, in the direction of the arrow II in FIG. 1;

FIG. 3 shows a side view of an embodiment of a power saw;

FIG. 4 shows a perspective, partial representation of the region of the first antivibration element of the power saws from FIGS. 1 to 3;

FIG. 5 shows a sectional representation through the antivibration element from FIG. 4, in a non-loaded state;

FIG. 6 shows a sectional representation through the antivibration element from FIG. 4 when the end faces of the holding elements bear against each other;

FIG. 6A shows a partial representation from FIG. 6 for an alternative embodiment variant;

FIG. 7 shows an exploded representation of the antivibration element from FIG. 4; and,

FIGS. 8 and 9 show perspective representation of the holding elements of the antivibration element from FIG. 7, from the side of the holding elements that is not visible in FIG. 7.

### DESCRIPTION OF THE PREFERRED EMBODIMENTS

FIG. 1 shows a handheld work apparatus 1. Represented in the embodiment is a handheld work apparatus, that is, a work apparatus 1 that is carried by the user during operation. The handheld work apparatus 1 in FIG. 1 is a power saw. The work apparatus 1 has a motor unit 2 and a handle unit 3. The handle unit 3 comprises a rear handle 7 on which an operator controlled element 8 is located. During operation, the operator controlled element 8 is located in the region of an index finger and/or middle finger of an operator. The operator controlled element 8 is located near a front side 16 of the rear handle 7. The front side 16 is the side of the handle 7 closer to a tool of the work apparatus 1. The thumb and/or index finger of an operator's hand are located close to the front side 16. During operation, the little finger of a user is comparatively distant from the front side 16. The little finger of an operator is closer than the operator's index finger to a rear side 17 of the rear handle 7. The handle unit 3 also comprises a bale handle 6. The work apparatus 1 may also alternatively be a cut-off grinder.

The work apparatus 1 of the embodiment has a saw chain 5, which forms the tool of the work apparatus 1. The saw chain 5 is arranged around a guide bar 4. In operation, the saw chain 5 is driven around the guide bar 4 by a drive motor 10. The drive motor 10 is part of the motor unit 2. The motor unit 2 is coupled to the handle unit 3 via a plurality of antivibration elements 11, 12, 13, 14. The work apparatus 1 also comprises a hand guard 9, which is located on the side of the bale handle 6 that faces away from the saw chain 5. The hand guard 9 may be provided for triggering a braking device, not represented, for the saw chain 5.

In FIG. 1 the work apparatus 1 is represented in a rest position 18, in which the work apparatus 1 stands on a flat, horizontal rest surface 19. The handle unit 3 is connected to the motor unit 2 via a first antivibration element 11, which comprises a coil spring 20. The coil spring 20 is held on the motor unit 2 via a first holding element 21, and on the handle unit 3 via a second holding element 22. The coil spring 20 has a longitudinal center axis 23. In the embodiment, the longitudinal center axis 23 is inclined at an angle α with respect to the rest surface 19. In the embodiment, the angle α is more than 0° and less than 90°. Preferably, the angle α is more than 45°. An angle α of 60° to 80° is considered to be particularly preferred. In an alternative embodiment, however, it may also be provided that the longitudinal center axis 23 runs parallel to the rest surface 19. In this case, it is particularly preferred that the longitudinal center axis 23 is oriented obliquely, in particular perpendicularly with respect to the plane of the drawing in FIG. 1. The longitudinal center axis 23 is preferably perpendicular to the plane of the guide bar 4.

In the embodiment according to FIG. 1, the drive motor 10 is an internal combustion engine, which draws in combustion air via an air filter 26 and an intake channel 27. The internal combustion engine is preferably a two-stroke engine, in particular a single-cylinder engine.

The longitudinal center axes of the antivibration elements 12, 13 and 14 are parallel to the plane of the guide bar 4.

In the embodiment, the handle unit 3 has a tank for operating medium, in particular a fuel tank 15. The fuel tank 15 is preferably integrated in a handle housing of the handle unit 3. In the embodiment, the second holding element 22 is located on the side of the fuel tank 15 that is at the top in the rest position 18.

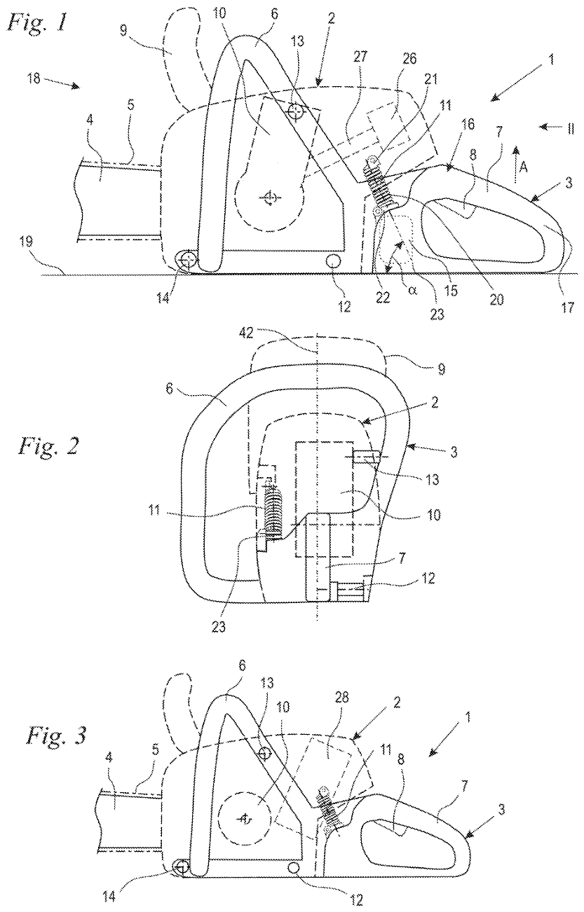

FIG. 2 shows the arrangement of the antivibration elements 11, 12 and 13. The work apparatus 1 has a longitudinal plane 42. The longitudinal plane 42 is preferably parallel to the rear handle 7. In the embodiment, the longitudinal plane 42 is parallel to the plane of the guide bar 4. As shown by FIG. 2, the longitudinal center axes of the coil springs of the antivibration elements 12 and 13 are perpendicular to the longitudinal plane 42. In the embodiment, the longitudinal center axis 23 of the first antivibration element 11 is parallel to the longitudinal plane 42. However, a different orientation of the first antivibration element 11 may also be advantageous.

FIG. 3 shows an embodiment of a work apparatus 1. The work apparatus 1 represented in FIG. 3 is also a handheld work apparatus, in the embodiment a manually portable work apparatus. In the embodiment, the work apparatus 1 is a power saw. The structure of the power saw 1, composed of a motor unit 2 and a handle unit 3 that are connected to each other via antivibration elements 11, 12, 13 and 14, corresponds to the structure represented in FIG. 1 and described with regard to FIG. 1. The work apparatus 1 from FIG. 3 differs from the work apparatus from FIG. 1 in that the drive motor 10 in the embodiment according to FIG. 3 is an electric motor. In an embodiment, the electric motor is powered by a battery 28. A different structure and/or a different type of power supply for the drive motor 10 may also be advantageous.

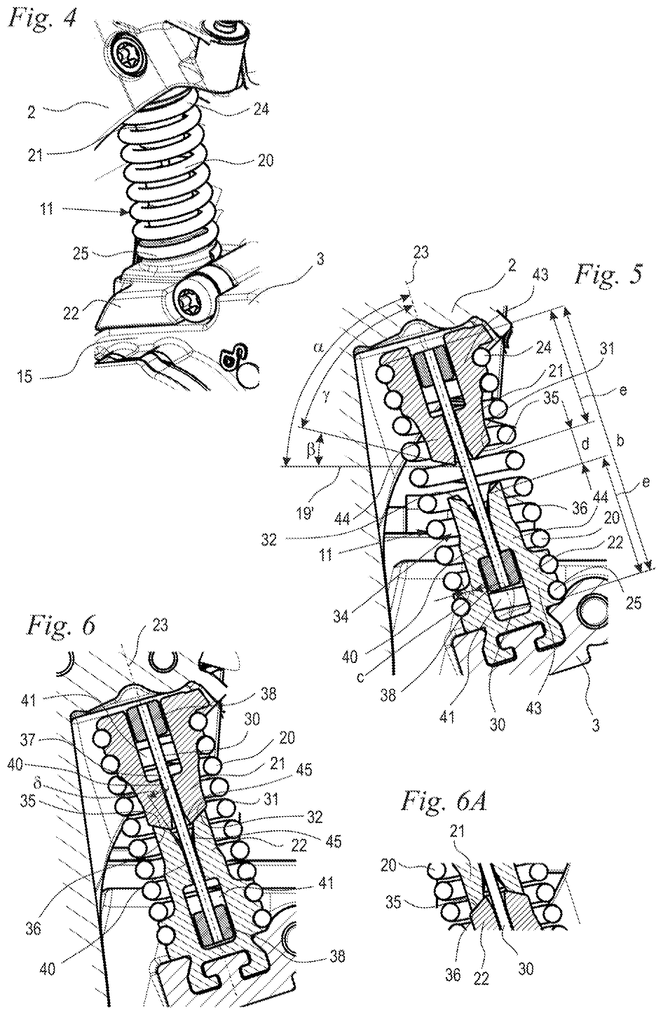

FIGS. 4 to 9 show the structure of the first antivibration element 11 in detail. The coil spring 20 has a first end 24, into which the first holding element 21 is screwed. This can also be seen in FIG. 5. The coil spring 20 has a second end 25, into which the second holding element 22 is screwed, as also represented in FIG. 5. The second holding element 22 is advantageously located on a side of a portion of the handle unit 3 that is an upper side in the rest position 18. If the work apparatus 1 has a fuel tank 15 on the handle unit 3, the second holding element 22 is advantageously located on the fuel 15, in the embodiment on the side of the fuel tank 15 located at the top in the rest position 18. In the case of work apparatus 1 that do not have a fuel tank 15, the second holding element 22 is advantageously located at a corresponding position. The coil spring 20 is advantageously exposed at its outer circumference. The coil spring 20 is advantageously not held at its outer circumference. The holding elements 21 and 22 advantageously do not fix the coil spring 20 at its outer circumference.

FIG. 5 shows the first antivibration element 11 when the handle unit 3 and motor unit 2 are in a non-loaded state. In this state, the coil spring 20 has a length b measured parallel to the longitudinal center axis 23. The coil spring 20 is held with its first end 24 on the first holding element 21. For this purpose, the coil spring 20 is advantageously screwed, by from one to three coils, into the holding element 21. A different number of coils of the coil spring 20 fixed to the holding element 21 may also be advantageous.

The first end 24 is held at a holding portion 43 of the holding element 21. The holding portion 43 has a helical groove 46 on its outer circumference for receiving the coil spring 20. A guide portion 44 of the holding element 21 adjoins the holding portion 43. In the guide portion 44, the coils of the coil spring 20 have a distance c from the holding element 21, measured perpendicularly with respect to the longitudinal center axis 23. In the guide portion 44, the coils of the coil spring 20 therefore do not bear against the holding element 21 in the non-loaded state. The guide portion 44 is inside the coil spring 20. In the embodiment, the guide portion 44 does not have a groove 46. It may also be provided, however, that the guide portion 44 has a groove from which the coil spring 20 is spaced in at least one direction, that is, in the radial and/or axial direction, in the non-loaded state for the purpose of adjusting the spring stiffness.

The holding element 21 has an end face 31 located in an interior 34 of the coil spring 20. The interior 34 is the inside of the coil spring 20 enclosed by the coil spring 20 and does not denote a space closed off from the outside. In the embodiment, the end face 31 of the holding element 21 is realized on the guide portion 44. There is a first centering element 35 located on the end face 31 of the holding element 21. There is second centering element 36 located on the end face 32 of the second holding element 22.

In the embodiment, the first centering element 35 is realized as a cone projecting toward the second holding element 22. The cone has a cone angle γ. The cone angle γ is the angle enclosed by the end face 31 and the longitudinal center axis 23 in a section through the longitudinal center axis 23. The cone angle γ is smaller than the angle α enclosed by the longitudinal center axis 23 and the rest surface 19 in the rest position 18 (FIG. 1). In FIG. 5 the angle α is drawn with respect to a line 19′, which is parallel to the rest surface 19. The cone angle γ is preferably at least 5° smaller than the angle of inclination α. The cone angle γ is advantageously 50° to 75°.

The centering element 35 and the line 19′ enclose a centering angle ß. The centering angle ß is the smallest angle enclosed by the centering element 35 and the rest surface 19. When the handle 7 is moved upward in relation to the rest position 18, the centering angle ß causes a force that centers the holding elements 21 and 22 with respect to the longitudinal center axis 23.

As also shown by FIG. 5, the second holding element 22 also has a holding portion 43 having a circumferential groove that is screwed into the coil spring 20. A guide portion 44 adjoins the holding portion 43. The holding element 22 has an end face 32 located in an interior 34 of the coil spring 20. There is a centering element 36 realized on the end face 32. The centering element 36 is preferably realized so as to complement the centering element 35, and acts in combination with it to center the holding elements 21 and 22, if the distance between the holding elements 21 and 22 is correspondingly small. In the embodiment, the centering element 36 is realized as a conical recess.

FIG. 6A shows an alternative embodiment, in which the first centering element 35 on the first holding element 21 is realized as a recess, in particular as a conical recess, and the second centering element 36 on the second holding element 22 is realized as a cone. The further structure of the arrangement corresponds to that of the preceding embodiment.

A breakaway safety device 30 projects through the interior 34 of the coil spring 20. The breakaway safety device 30 is preferably realized as a steel cable. Another configuration of the breakaway safety device 30 may also be provided. The ends of the breakaway safety device 30 are held on the holding elements 21 and 22. In the event of a breakage of the coil spring 20, the motor unit 2 and handle unit 3 are thus connected to each other via the breakaway safety device 30.

As shown by FIG. 5, the end faces 31 and 32 are at a distance d from each other in the non-loaded state. The distance d is advantageously at most 30%, in particular at most 20% of the length b of the coil spring 20. Advantageously, the distance d in the non-loaded state is at most 3 cm, in particular at most 2 cm. The non-loaded state in this case is the state of the work apparatus 1 in which the work apparatus 1 stands on the rest surface 19 with the drive motor 10 switched off and no external forces act upon the work apparatus 1. As a result, the end faces 31 and 32 act as a stop between the motor unit 2 and the handle unit 3, for example in the case of large loads. The distance b is smaller than the difference between the length b of the coil spring 20 in the non-loaded state and the block length of the coil spring 20. As a result, the end faces 31 and 32 can come into contact with each other and act as a stop.

The holding portion 43 and the guide portion 44 of each holding element 21, 22 have a common length e. The common length e is measured parallel to the longitudinal center axis 23 of the coil spring 20. The common length e corresponds to the length over which the holding element 21, 22 projects into the interior 34 of the coil spring 20. The common length e is advantageously at least 30%, in particular at least 35%, of the length b of the coil spring 20 for at least one holding element 21 or 22, in particular for both holding elements 21 and 22.

If the handle 7, in the rest position 18 represented in FIG. 1 and FIG. 3, is moved upward, that is, in the direction A represented in FIG. 1, the holding elements 21 and 22 move toward each other until the end faces 31 and 32 of the holding elements 21 and 22 come into contact with each other. The centering elements 35 and 36 thereby center the holding elements 21 and 22 with respect to each other and to the longitudinal center axis 23.

The breakaway safety device 30 includes a safety cable 37, in particular a steel cable. The safety cable 37 is preferably a shear-resistant cable. At its ends, the safety cable 37 has nipples 38, which have an enlarged outer diameter compared to the safety cable 37. The nipples 38 are located in receivers 41 of the holding elements 21 and 22. A pass-through opening 40 leads from each of the receivers 41 to the end faces 31 and 32. The inner diameter of the pass-through opening is dimensioned such that the assigned nipple 38 cannot pass through the pass-through opening 40. The safety cable 37 thus limits the maximum distance of the holding elements 21 and 22 in the event of a breakage of the coil spring 20. In the portion of the pass-through openings 40 that adjoins the end faces 31 and 32, there is an expanded portion 45 provided in each case. In the expanded portion 45, the inner diameter of the pass-through opening 40 increases in the direction of the end face 31, 32 of the holding element 21 or 22 in which the pass-through opening 40 is located. The expanded portion 45 may also be advantageously realized as a conical recess. The angle δ between the wall of the expanded portion 45 and the longitudinal center axis 23, which is drawn in FIG. 6, may be, for example, 5° to 20°.

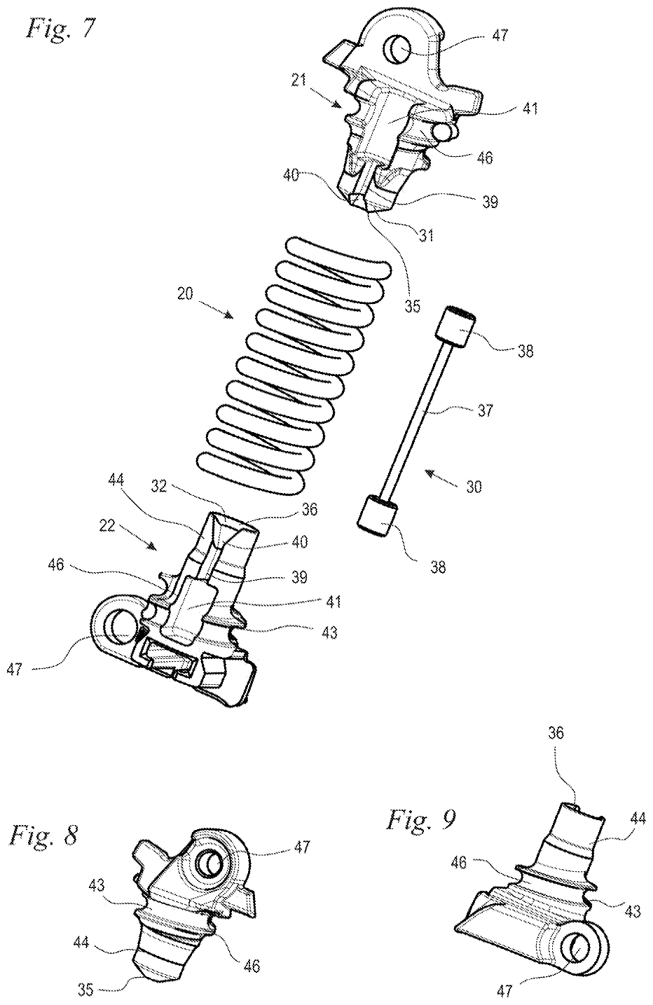

To enable easy mounting of the breakaway safety device 30, the pass-through opening 40, as shown by FIG. 7, is connected to the circumference of the holding element 21 or 22 via a slit 39. In the embodiment, the slit 39 connects the pass-through opening 40 to the outer circumference in the guide portion 44.

For the purpose of fastening to adjoining components, each holding element 21, 22 has at least one fastening opening 47. In the assembled state, a fastening screw, for example, may project through the fastening openings 47, fixing the holding element 21 to the motor unit 2, and the holding element 22 to the handle unit 3, for example in the region of a fuel tank 15.

The holding elements 21 and 22 are preferably made of plastic. The coil spring 20 is advantageously a steel spring. The fact that the centering elements 35, 36 can come into contact with one another means in this case that, upon a movement of the handle 7 intended for operation, contact of the centering elements 35 and 36 can occur.

The holding elements 21 and 22 may advantageously be made of at least two differing materials. The holding elements 21 and 22 may advantageously be produced by two-component injection molding. Advantageously, the holding elements 21 and 22 are made from a soft component in the region of the front sides 31 and 32. The centering elements 35 and 36 are made, in particular, from an elastic material, preferably an elastomer. The holding portion 43 is advantageously made of a dimensionally stable plastic.

The terms “radial” and “axial” herein refer throughout to the radial direction of the longitudinal center axis of the coil spring, that is, perpendicular to the longitudinal center axis of the coil spring, and to the direction parallel to the longitudinal center axis of the coil spring.

It is understood that the foregoing description is that of the preferred embodiments of the invention and that various changes and modifications may be made thereto without departing from the spirit and scope of the invention as defined in the appended claims.

What is claimed is:

1. A handheld work apparatus comprising:
a tool;
a motor unit having a drive motor configured to drive said tool;
a handle unit including a handle;
said motor unit and said handle unit being connected to each other via at least one antivibration element;
said at least one antivibration element including a first antivibration element having a coil spring, a first holding element, and a second holding element;
said first holding element being attached in a first end of said coil spring;
said second holding element being attached in a second end of said coil spring;
said first holding element being firmly connected to said motor unit;
said second holding element being firmly connected to said handle unit;
said first holding element having a first end face located in an interior of said coil spring;
said second holding element having a second end face located in the interior of said coil spring;
said first end face having a first centering element;
said second end face having a second centering element;
said first centering element and said second centering element being configured to come into mutual contact and thereby center said first holding element and said second holding element with respect to each other; and,
said first end face and said second end face forming a stop for a movement of said handle.

2. The work apparatus of claim 1, wherein said first holding element and said second holding element are dimensionally stable.

3. The work apparatus of claim 1, wherein said first centering element is a cone and said second centering element is a recess; or, said first centering element is a recess and said second centering element is a cone.

4. The work apparatus of claim 1, wherein said first holding element is screwed into said first end of said coil spring; and, said second holding element is screwed into said second end of said coil spring.

5. The work apparatus of claim 1, wherein said coil spring defines a longitudinal center axis; wherein, when the work apparatus is in a rest position, in which the work apparatus stands on a flat, horizontal rest surface, the longitudinal center axis is inclined by an angle of inclination (α) with respect to the flat, horizontal rest surface.

6. The work apparatus of claim 5, wherein said first centering element is a cone and said second centering element is a recess or said first centering element is a recess and said second centering element is a cone; and, a cone angle (γ) of said cone is smaller than the angle of inclination (α) of the longitudinal center axis of the coil spring.

7. The work apparatus of claim 6, wherein said cone angle (γ) is at least 5° smaller than said angle of inclination (α) of the longitudinal center axis.

8. The work apparatus of claim 5, wherein said angle of inclination (α) is greater than 45°.

9. The work apparatus of claim 1, wherein said first antivibration element has a breakaway safety device having ends held in corresponding ones of said first and second holding elements; and, said first holding element and said second holding element each have an outer circumference and a slit extending from a circumference of a pass-through opening for said breakaway safety device to said outer circumference of a corresponding one of said first holding element and said second holding element.

10. The work apparatus of claim 1, wherein each of said first holding element and said second holding elements defines a pass-through opening expanding, in at least one longitudinal portion of a corresponding one of said holding elements, in a direction of a corresponding one of said first end face and said second end face.

11. The work apparatus of claim 1, wherein, when the work apparatus is in a non-loaded state, said first end face and said second end face are at a distance (d) from each other; said coil spring has a length (b); and, said distance (d) is at most 30% of said length (b) of said coil spring.

12. The work apparatus of claim 11, wherein said distance (d), when the work apparatus is in the non-loaded state, is at most 20% of said length (b) of said coil spring.

13. The work apparatus of claim 1, wherein said first holding element and said second holding element are made of plastic.

14. The work apparatus of claim 1, wherein said first centering element and said second centering element come into contact with each other when said handle is moved in a direction (A) that corresponds to an upward movement when the work apparatus is in a rest position.

15. The work apparatus of claim 1, wherein said first antivibration element is located adjacent to a front side of said handle that faces toward said tool.

16. The work apparatus of claim 1, wherein the handheld work apparatus is a power saw.
